(19) United States
(12) Patent Application Publication
(10) Pub. No.: US 2024/0342696 A1
(43) Pub. Date: Oct. 17, 2024

(54) METHOD OF PREPARING AQUEOUS PHASE REFORMING CATALYSTS

(71) Applicant: VIRENT, INC., Madison, WI (US)

(72) Inventors: Colin Anson, Madison, WI (US); Edgar Steenwinkel, Madison, WI (US)

(21) Appl. No.: 18/632,208

(22) Filed: Apr. 10, 2024

Related U.S. Application Data
(60) Provisional application No. 63/496,291, filed on Apr. 14, 2023.

(51) Int. Cl. B01J 37/02; B01J 21/18; B01J 23/656; B01J 33/00; B01J 35/30; B01J 37/08; B01J 37/18; C01B 3/32

(52) U.S. Cl. CPC B01J 37/024; B01J 21/18; B01J 23/6567; B01J 33/00; B01J 35/392; B01J 35/394; B01J 37/0236; B01J 37/08; B01J 37/18; C01B 3/326; C01B 2203/0227; C01B 2203/107; C01B 2203/1082; C01B 2203/1211

(57) ABSTRACT

The present disclosure provides an improved method for preparing a carbon supported Pt—Re catalyst (Pt—Re/C) using a soluble non-chlorinated Pt material as a Pt source. The catalysts prepared by the methods described herein can achieve the same level of catalytic capacity as that of the catalysts prepared by the conventional method using chlorinated Pt precursors.

### CROSS-REFERENCE TO RELATED APPLICATIONS

This application claims priority to U.S. Provisional patent application No. 63/496,291, filed on Apr. 14, 2023, the content of which is hereby incorporated by reference in its entirety.

### BACKGROUND

As a promising alternative to petroleum-based fuels and chemicals, bioreforming processes provide liquid fuels and chemicals derived from biomass, such as cellulose, hemicellulose, and lignin found in plant cell walls. For instance, cellulose and hemicellulose can be used as feedstock for various bioreforming processes, including aqueous phase reforming (APR) and hydrodeoxygenation (HDO)-catalytic reforming processes that, when integrated with hydrogenation, can convert cellulose and hemicellulose into hydrogen and hydrocarbons, including liquid fuels and other chemical products. In an APR process, hydrogen is produced from water-soluble oxygenate species at temperatures and pressures lower than those used in conventional steam methane reforming (SMR) technology. For example, an APR process may include contacting water and an oxygenated hydrocarbon (such as ethylene glycol, propylene glycol, glycerol, sorbitol, etc.) with a catalyst in either the liquid or vapor phase. Through a series of reactions, H₂ and CO are produced. Under the APR conditions, the water-gas shift (WGS) equilibrium favors H₂/CO₂ production through the water-gas shift reaction, and CO+H₂O are converted into H₂ and CO₂. Small amounts of gaseous alkanes (CH₄, C₂H₆, C₃H₈, etc.) and water soluble oxygenates (MeOH, EtOH, acetone, iPrOH, etc.) are also produced as byproducts. APR methods are described, for example, in U.S. Pat. Nos. 6,699,457, 6,964,757, 6,964,758, and 7,618,612 (all to Cortright et al., entitled “Low-Temperature Hydrogen Production from Oxygenated Hydrocarbons”) and U.S. Pat. No. 6,953,873 (to Cortright et al., entitled “Low-Temperature Hydrocarbon Production from Oxygenated Hydrocarbons”), all of which are incorporated herein in their entireties by reference.

Currently, Pt-based catalysts can be prepared in a one-step or two-step impregnation process using chlorinated Pt salts as precursors. For carbon-supported Pt—Re catalysts, as an example, a carbon support can be impregnated with an aqueous solution of H₂PtCl₆ and HReO₄ as the Pt and Re precursors, respectively. Simonetti et al. (J. Catal. 2007, 247, 298-306) reported preparation of carbon-supported Pt and Re catalysts by a one-step incipient wetness impregnation of carbon black with aqueous solutions of H₂PtCl₆·6H₂O and HReO₄. King et al. (Appl. Catal. B. Environ. 2010, 99, 206-213) reported a two-step incipient wetness impregnation process to make Pt—Re/C catalyst using Pt(NH₃)₄(NO₃)₂ and HReO₄ as the platinum and rhenium sources. In the first step, carbon was impregnated with (NH₃)₄Pt(NO₃)₂ and the resulting material was dried and calcined. In the second step, the calcined Pt/C material was impregnated with HReO₄ solution, and the resulting product was dried and calcined to provide a Pt—Re/C catalyst. Ciftci et al. (J. Catal. 2014, 311, 88-101) reported a similar two-step process to prepare Pt—Re/C catalysts by impregnating the carbon support with solutions of H₂PtCl₆·6H₂O and HReO₄.

However, the use of chlorinated Pt salts (e.g., H₂PtCl₆) is problematic. When these catalysts are dried and/or reduced, significant amount of HCl gas is produced, which can corrode or destroy stainless steel contains and equipment, causing safety and environmental problems. On the other hand, non-chlorinated Pt salt (such as the nitrate salt used in King et al.) can be difficult to solubilize in water, thus making incipient wetness impregnation processes practically impossible on a production scale. Thus, there remains a need for alternative methods to prepare active Pt-based catalyst using less toxic, less corrosive, and more soluble materials.

### SUMMARY OF THE INVENTION

Described herein methods for preparing a carbon supported Pt—Re catalyst (Pt—Re/C) using a non-chlorinated Pt material as a Pt source.

In one aspect, the present disclosure provides a method of preparing a catalyst, which comprises contacting (NH₃)₄Pt(OH)₂, a carbon support, and a rhenium material to produce a Pt—Re/C catalyst.

In some embodiments, the present method comprises mixing a solution of (NH₃)₄Pt(OH)₂ with a carbon support to form a mixture; drying the mixture to produce a Pt/C intermediate; and impregnating the Pt/C intermediate with an aqueous solution of the rhenium material to produce the Pt—Re/C catalyst.

In some embodiments, the present method comprises mixing a solution of (NH₃)₄Pt(OH)₂, the carbon support, and the rhenium material to form a Pt—Re/C mixture; and heating the Pt—Re/C mixture to produce the Pt—Re/C catalyst.

In some embodiments, the carbon support comprises activated carbon, such as activated carbon in powder or granular form.

In some embodiments, the solution of (NH₃)₄Pt(OH)₂ has a Pt concentration of about 1 wt % to about 15 wt %, including for example about 5 wt % to about 15 wt %.

In some embodiments, the weight ratio of Pt to carbon is about 1:1000 to about 1:10.

In some embodiments, the solution of (NH₃)₄Pt(OH)₂ is a solution of (NH₃)₄Pt(OH)₂ in water.

In some embodiments, the rhenium material comprises HReO₄.

In some embodiments, the HReO₄ is in an aqueous solution having a Re concentration of about 0.1 wt % to about 10 wt %, including for example about 0.25 wt % to about 10 wt %.

In some embodiments, the weight ratio of Re to carbon is about 1:2000 to about 1:20.

In some embodiments, the solution of HReO₄ is a solution of HReO₄ in water.

In some embodiments, impregnating the Pt/C intermediate with an aqueous solution of the rhenium material comprises contacting the aqueous solution of HReO₄ with the Pt/C intermediate.

In some embodiments, the Pt/C intermediate is dried by heating, for example, at a temperature of about 100° C. to about 160° C. for at least 4 hours, such as about 6 hours to about 24 hours.

In some embodiments, the method further comprises reducing the Pt—Re/C catalyst with hydrogen to produce a reduced catalyst.

In some embodiments, the method further comprises subjecting the reduced catalyst to passivation with oxygen.

In another aspect, the present disclosure provides a catalyst produced by the method as described herein. In some embodiments, the catalyst has a has a metallic area of about 3.0 to about 4.0 m²/g. In some embodiments, the catalyst has a percent dispersion of about 15% to about 25%.

In yet another aspect, the present disclosure provides a method of producing hydrogen, which comprises reacting water and an oxygenated hydrocarbon in the presence of the catalyst produced by the method as described herein, whereby hydrogen is produced.

In some embodiments, the oxygenated hydrocarbon is a water-soluble oxygenated hydrocarbon. In some embodiments, the oxygenated hydrocarbon is glycerol.

### BRIEF DESCRIPTION OF DRAWINGS

FIG. 1 shows catalytic activity of the present chlorine-free catalyst as compared to a conventional chlorine-containing catalyst (produced by BASF). Data represent the conversion to gas and H₂ yields for each of the present Cl-free catalyst and the conventional Cl-containing catalyst. The conditions for these tests are: 36 wt % USP-grade glycerol, 260° C. isothermal operation, 625 psig, WHSV=1 hr⁻¹.

### DETAILED DESCRIPTION OF THE INVENTION

The present disclosure relates to improved method for preparing a carbon supported Pt—Re catalyst (Pt—Re/C) using a soluble non-chlorinated Pt material as a Pt source. Remarkably, the present disclosure avoids the harmful effects of using a chlorinated Pt precursor in known preparation procedures. Further, the present method can be implemented on a production scale to provide large quantity of effective catalyst. The catalysts prepared by the methods described herein can achieve the same level of catalytic capacity as that of the catalysts prepared by the conventional method using chlorinated Pt precursors.

In one aspect, the present disclosure provides a method of preparing a catalyst, the method comprising: contacting (NH₃)₄Pt(OH)₂, a carbon support, and a rhenium material to produce a Pt—Re/C catalyst. The resulting Pt—Re/C catalyst is understood to be a carbon supported catalyst comprising Pt and Re metals.

The present method can include generation of an intermediate product (e.g., in a two-step process). In some embodiments, the method comprises: mixing a solution of (NH₃)₄Pt(OH)₂ with a carbon support to form a mixture; drying the mixture to produce a Pt/C intermediate; and impregnating the Pt/C intermediate with an aqueous solution of the rhenium material to produce the Pt—Re/C catalyst.

The term “impregnating” includes embedding, depositing, or dispersing, a substance (such as the rhenium material in an aqueous solution) in at least a portion of a solid subject or product (such as the Pt/C intermediate). The impregnating process can include mixing a liquid solution containing the substance with the solid product, contacting the solid product with the liquid solution, and/or soaking the solid product in the liquid solution. Suitable impregnation technologies include incipient wetness impregnation and other known procedures. Heating and stirring may be included to improve the impregnation process. For example, the Pt/C intermediate can be added to, or mixed with, the aqueous solution containing the rhenium material, such that the rhenium material can be deposited on the surface of, or dispersed throughout, at least a portion of the Pt/C intermediate to produce the Pt—Re/C catalyst.

In some embodiments, the Pt/C intermediate is dried by heating at a temperature of about 100° C. to about 160° C. for at least 4 hours. For example, the Pt/C intermediate can be dried prior to being impregnated with the rhenium material. The drying temperature can be about 100° C. to about 150° C., about 100° C. to about 140° C., about 110° C. to about 150° C., about 120° C. to about 130° C., or about 130° C. to about 140° C. In some embodiments, the drying temperature is about 130° C., about 140° C., or about 150° C. In some embodiments, the drying temperature is about 140° C. The Pt/C intermediate can be dried for at least 6 hours, at least 8 hours, at least 12 hours, at least 16 hours, at least 20 hours, or at least 24 hours. The drying time can depend on the drying temperature and the quantity of the Pt/C intermediate. In some embodiments, the drying time is about 4 hours to about 24 hours, about 6 hours to about 24 hours, about 6 hours to about 18 hours, or about 6 hours to about 12 hours. In some embodiments, the drying time is about 6 hours, about 12 hours, or about 24 hours. In some embodiments, the Pt/C intermediate is dried by heating at about 140° C. for about 6 hours to about 12 hours (e.g., overnight). Conventional technology (e.g., King et al.) requires calcination of the catalyst at elevated temperatures (e.g. 260° C.), which may cause thermal decomposition. In comparison, the Pt/C intermediate as disclosed herein may be dried at reduced temperature (e.g., 160° C. or lower) to avoid calcination. Advantageously, the drying conditions of the present method may reduce the risk of decomposition of the Pt/C intermediate.

The present method can be carried out by mixing a solution of (NH₃)₄Pt(OH)₂, the carbon support, and the rhenium material to form a Pt—Re/C mixture; and drying the Pt—Re/C mixture to produce the Pt—Re/C catalyst. In some embodiments, the carbon support is impregnated with both Pt and Re from the Pt—Re/C mixture. The drying of the Pt—Re/C mixture can be accomplished, for example, by heating, vacuum drying, air drying, or a combination thereof.

The carbon support can provide a stable platform for the Pt and Re in catalyst. The carbon support can be a powder, a granule (or a granular solid), or an extruded solid. In some embodiments, the carbon support comprises activated carbon, such as activated carbon in powder or granular forms. Suitable carbon support includes commercial products, such as Calgon 208C granular activated carbon (Calgon Carbon Corp., PA).

The solution of (NH₃)₄Pt(OH)₂ can be, for example, an aqueous solution. As used herein, an “aqueous solution” of a substance means a solution of the substance dissolved in an aqueous solvent. The aqueous solvent can comprises water or a combination of water and at least one organic solvent, such as alcohol or ketone. The pH and ionic strength of the aqueous solvent can be adjusted to improve solubility of the substance or its impregnation properties. In some embodiments, the solution of (NH₃)₄Pt(OH)₂ is a solution of (NH₃)₄Pt(OH)₂ in water.

In some embodiments, the solution of (NH₃)₄Pt(OH)₂ has a Pt concentration of about 1 wt % to about 15 wt %. The Pt concentration can be about 1 wt % to about 14 wt %, about 1 wt % to about 13 wt %, about 1 wt % to about 12 wt %, about 1 wt % to about 11 wt %, about 1 wt % to about 10 wt %, about 5 wt % to about 15 wt %, about 5 wt % to about 14 wt %, about 5 wt % to about 13 wt %, about 5 wt % to about 12 wt %, about 5 wt % to about 11 wt %, about 5 wt % to about 10 wt %, about 10 wt % to about 14 wt %, or about 10 wt % to about 13 wt %, In some embodiments, the solution of (NH₃)₄Pt(OH)₂ has a Pt concentration of about 1 wt %, about 2 wt %, about 3 wt %, about 4 wt %, about 5 wt %, about 6 wt %, about 7 wt %, about 8 wt %, about 9 wt %, about 10 wt %, about 11 wt %, or about 12 wt %.

The amount of Pt relative to carbon support can be adjusted in Pt—Re/C catalyst produced by the present method. In some embodiments, the weight ratio of Pt to carbon is about 1:1000 to about 1:10. The weight ratio of Pt to carbon can be about 1:800 to about 1:10, about 1:600 to about 1:10, about 1:400 to about 1:10, about 1:300 to about 1:10, about 1:200 to about 1:10, about 1:100 to about 1:10, about 1:80 to about 1:10, about 1:60 to about 1:10, about 1:40 to about 1:10, about 1:1000 to about 1:20, about 1:800 to about 1:20, about 1:600 to about 1:20, about 1:400 to about 1:20, about 1:100 to about 1:20, about 1:80 to about 1:20, about 1:60 to about 1:20, or about 1:40 to about 1:20. In some embodiments, the weight ratio of Pt to carbon is about 1:800, about 1:400, about 1:100, about 1:80, about 1:60, about 1:40, about 1:30, about 1:20, or about 1:15. In some embodiments, the weight ratio of Pt to carbon is about 1:20.

Suitable rhenium material includes those used in the reported preparation procedures, such as HReO₄ and other oxides, sulfides, and alloys of rhenium. In some embodiments, the rhenium material comprises HReO₄. The HReO₄ can be dissolved in an aqueous solvent to form an aqueous solution for use in the present method. In some embodiments, the aqueous solution of HReO₄ is a solution of HReO₄ in water.

In some embodiments, the HReO₄ is in an aqueous solution having a Re concentration of about 0.25 wt % to about 10 wt %. The Re concentration can be about 0.25 wt % to about 9 wt %, about 0.25 wt % to about 8 wt %, about 0.25 wt % to about 7 wt %, about 0.25 wt % to about 6 wt %, about 0.25 wt % to about 5 wt %, about 0.25 wt % to about 4 wt %, about 1 wt % to about 10 wt %, about 1 wt % to about 5 wt %, about 2 wt % to about 10 wt %, about 2 wt % to about 5 wt %, or about 5 wt % to about 10 wt %. In some embodiments, the Re concentration in the aqueous solution is about 0.5 wt %, about 1 wt %, about 2 wt %, about 3 wt %, about 4 wt %, about 5 wt %, about 6 wt %, about 7 wt %, about 8 wt %, about 9 wt %, or about 10 wt %.

The amount of Re relative to carbon support can be adjusted in Pt—Re/C catalyst produced by the present method. In some embodiments, the weight ratio of Re to carbon is about 1:2000 to about 1:20. The weight ratio of Re to carbon can be about 1:1800 to about 1:20, about 1:1500 to about 1:20, about 1:1200 to about 1:20, about 1:1000 to about 1:20, about 1:800 to about 1:20, about 1:600 to about 1:20, about 1:400 to about 1:20, about 1:200 to about 1:20, about 1:150 to about 1:20, about 1:120 to about 1:20, about 1:100 to about 1:20, about 1:80 to about 1:20, about 1:60 to about 1:20, about 1:2000 to about 1:40, about 1:1500 to about 1:40, about 1:1000 to about 1:40, about 1:800 to about 1:40, about 1:400 to about 1:40, about 1:200 to about 1:40, or about 1:100 to about 1:40. In some embodiments, the weight ratio of Re to carbon is about 1:1000, about 1:800, about 1:600, about 1:400, about 1:200, about 1:100, about 1:80, about 1:60, about 1:50; about 1:40, or about 1:30. In some embodiments, the weight ratio of Pt to carbon is about 1:40 or about 1:30.

In some embodiments, impregnating the Pt/C intermediate with an aqueous solution of the rhenium material comprises contacting the aqueous solution of HReO₄ with the Pt/C intermediate. In some embodiments, the product from impregnating the Pt/C intermediate with the aqueous solution of HReO₄ is then be dried to produce the Pt—Re/C catalyst.

The Pt—Re/C catalyst produced herein here can be further processed, including drying, reduction, and passivation. For example, the Pt—Re/C catalyst can be dried to provide a solid product. In some embodiment, the present method further comprises reducing the Pt—Re/C catalyst with hydrogen to produce a reduced catalyst. The hydrogen can have a flow rate of about 200 mL/min to about 300 mL/min and the reduction can be carried out at a temperature of about 200° C. to about 400° C. or about 300° C. to about 400° C. In some embodiments, the present method further comprises subjecting the reduced catalyst to passivation with oxygen (such as 1% O₂).

In another aspect, the present disclosure provides a catalyst produced by the method as described herein. The catalyst prepared by the present method can have similar physical and chemical properties (such as surface area, mechanical strength, and catalytic capacity) as those of a catalyst prepared from a chlorinated Pt precursor (such as H₂PtCl₆).

In some embodiments, the catalyst is prepared by a method as described herein, which comprises: mixing a solution of (NH₃)₄Pt(OH)₂ with a carbon support to form a mixture; drying the mixture to produce a Pt/C intermediate; and impregnating the Pt/C intermediate with an aqueous solution of a rhenium material to produce the Pt—Re/C catalyst.

In some embodiments, the catalyst is prepared by a method as described herein, which comprises: mixing a solution of (NH₃)₄Pt(OH)₂, a carbon support, and a rhenium material to form a Pt—Re/C mixture; and drying the Pt—Re/C mixture to produce the Pt—Re/C catalyst.

In some embodiments, the catalyst has a metallic area of about 3.0 to about 4.0 m²/g. The metallic area can be, for example, about 3.2 m²/g to about 3.8 m²/g or about 3.3 m²/g to about 3.7 m²/g. In some embodiments, the metallic area is about 3.2 m²/g, about 3.3 m²/g, about 3.4 m²/g, about 3.5 m²/g, about 3.6 m²/g, about 3.7 m²/g, or about 3.8 m²/g.

In some embodiments, the catalyst has a percent dispersion of about 15% to about 25%. The percent dispersion can be, for example, about 17% to about 25%, about 18% to about 25%, or about 20% to about 25%. In some embodiments, the percent dispersion is about 17%, about 18%, about 19%, about 20%, about 21%, about 22%, about 23%, or about 24%.

The Pt—Re/C catalyst produced by the present method can be useful as a catalyst for aqueous phase reforming (APR) reactions. In another aspect, the present disclosure provides a method of producing hydrogen, which comprises reacting water and an oxygenated hydrocarbon in the presence of the catalyst produced by the method described herein, whereby hydrogen is produced.

As described herein, the APR reaction can take place in the vapor phase, in the same fashion as conventional steam reforming reactions (although at a much lower temperature). The reaction can also take place in the condensed liquid phase, in which case the reactants (water and an oxygenated hydrocarbon) remain condensed liquids, as opposed to being vaporized prior to reaction. The reaction can also be carried out with one reactant, such as water, in the vapor phase and another component, such as the oxygenated hydrocarbon, in the condensed phase. The APR reaction can be carried out in any suitable reactor system, such as those disclosed in U.S. Pat. No. 6,699,457 (incorporated herein by reference in its entirety).

Suitable oxygenated hydrocarbons include those that are water-soluble and have at least two carbons. In some embodiments, the oxygenated hydrocarbon has from 2 to 12 carbon atoms. In some embodiments, the oxygenated hydrocarbon has from 2 to 6 carbon atoms. In some embodiments, the oxygenated hydrocarbon has a carbon-to-oxygen ratio of 1:1, regardless of the number of carbon atoms in the oxygenated hydrocarbon.

In some embodiments, the oxygenated hydrocarbon is a water-soluble oxygenated hydrocarbon selected from the group consisting of ethanediol, ethanedione, glycerol, glyceraldehyde, aldotetroses, aldopentoses, aldohexoses, ketotetroses, ketopentoses, ketohexoses, alditols, and a combination thereof. In some embodiments, the carbon oxygenated hydrocarbon is a C₃, C₄, C₅, or C₆ hydrocarbon (having 3, 4, 5, or 6 carbon atoms, respectively), or a combination thereof. Suitable C₆ oxygenated hydrocarbons include, for example, aldohexoses and corresponding alditols, such as glucose and sorbitol. Suitable oxygenated hydrocarbons having more than 6 carbon atoms include, for example, sucrose and oligosaccharides. In some embodiments, the oxygenated hydrocarbon includes smaller compounds, such as ethanediol, glycerol, glyceraldehyde, or a combination thereof.

Vapor phase reforming requires that the oxygenated hydrocarbon reactants have a sufficiently high vapor pressure at the reaction temperature so that the reactants are in the vapor phase. In particular, suitable oxygenated hydrocarbon compounds for vapor phase method of the present disclosure include, but are not limited to, ethanediol, glycerol, glyceraldehyde, and a combination thereof. Where the reaction is to take place in the liquid phase, suitable oxygenated hydrocarbons include, for example, glucose, sorbitol, sucrose, and a combination thereof.

In some embodiments, the oxygenated hydrocarbon comprises glycerol. In the present method of producing hydrogen, the feed stream can be prepared, for example, by mixing the oxygenated hydrocarbon compound and water to form an aqueous solution.

The performance of the catalytic process using the Pt—Re/C catalyst as described herein can be measured by, for example, hydrogen (H₂) yield and gas conversion rate. H₂ yield is a calculation of the amount of H₂ produced relative to the theoretical limit. For example, for glycerol, the theoretical maximum is 7 mols H₂ produced per mol of glycerol (C₃H₈O₃+3 H₂O→3 CO₂+7 H₂). Gas conversion rate is a measurement of the amount of carbon that is converted into gaseous products, such as CO, CO₂, CH₄, C₂H₆, C₃H₈, etc. Typically, lower conversion to gas efficiency occurs before significant H₂ yield losses. As such, gas conversion rate is an important leading metric for system performance. The gas conversion rate can be calculated by taking the flow rate of carbon out of the reactor (e.g., g carbon/minute) and dividing it by the flow of carbon into the reactor (e.g. g carbon/minute). For example, a sample of the aqueous effluent from the catalytic process can be taken and the total organic carbon (TOC) in the sample can be analyzed to determine the carbon content of the aqueous effluent.

Unless defined otherwise, all technical and scientific terms used herein have the same meaning as commonly understood by one of ordinary skill in the art to which the invention pertains. All definitions, as defined and used herein, should be understood to control over dictionary definitions, definitions in documents incorporated by reference, and/or ordinary meanings of the defined terms. As used herein, the terms “include” and “including” have the same meaning as the terms “comprise” and “comprising.” The terms “comprise” and “comprising” should be interpreted as being “open” transitional terms that permit the inclusion of additional components further to those components recited in the claims. The terms “consist” and “consisting of” should be interpreted as being “closed” transitional terms that do not permit the inclusion of additional components other than the components recited in the claims. The term “consisting essentially of” should be interpreted to be partially closed and allowing the inclusion only of additional components that do not fundamentally alter the nature of the claimed subject matter. As used herein, the singular forms “a”, “an”, and “the” include plural embodiments unless the context clearly dictates otherwise. The modifier “about” used in connection with a quantity is inclusive of the stated value and has the meaning dictated by the context (for example, it includes at least the degree of error associated with the measurement of the particular quantity). The modifier “about” should also be considered as disclosing the range defined by the absolute values of the two endpoints. For example, the expression “from about 2 to about 4” also discloses the range “from 2 to 4.” The term “about” may refer to plus or minus 10% of the indicated number. For example, “about 10%” may indicate a range of 9% to 11%, and “about 1” may mean from 0.9-1.1.

The present invention has been described in terms of one or more preferred embodiments, and it should be appreciated that many equivalents, alternatives, variations, and modifications, aside from those expressly stated, are possible and within the scope of the invention.

### EXAMPLES

A non-chlorinated Pt salt, (NH₃)₄Pt(NO₃)₂ were first tested as a precursor for Pt catalyst, similar to the process reported by King et al. (Appl. Catal. B. Environ., 2010, 99, 206-213) and Zhang et al. (J. Catal., 2012, 287, 37-43). However, solubilization of this salt in water was not successful, so an incipient wetness impregnation method was not possible. An alternative salt, (NH₃)₄Pt(OH)₂, was instead tested. This salt is soluble in water and is supplied either as an aqueous solution or as a water-soluble solid. A two-step synthesis was performed as follows.

To 15.1 g of Calgon 208C (80×120 mesh, which was crushed, washed, and dried from 6×12 mesh starting material) was added 7.752 g of (NH₃)₄Pt(OH)₂ solution (10.53 wt % Pt, sourced from Alfa Aesar) with 2.37 g water. This material was dried at 140° C. overnight. Next, 0.80 g of HReO₄ (52 wt % Re, Strem) was dissolved in 10.74 g water and added to the support. This catalyst was again dried overnight. The catalyst was then reduced in a packed bed reactor with an H₂ flow rate of 250 mL/min, with the temperature ramped to 350° C. over 4 hours and a 2-hour soak before cooling to room temperature and passivated with 1% O₂.

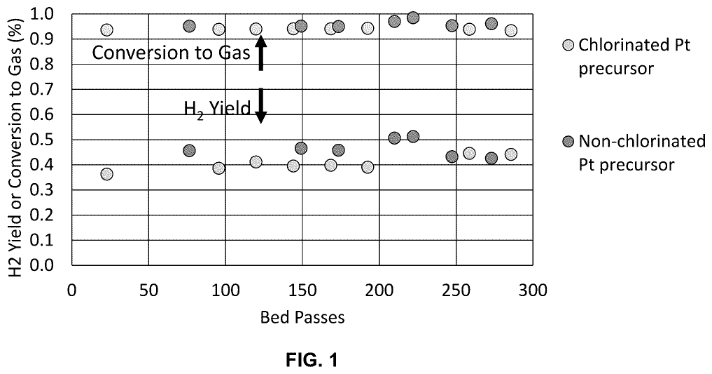

The performance of the catalyst was then compared to the performance of a conventional chloride-containing catalyst (prepared by BASF) (FIG. 1). The catalytic activities were tested with 36 wt % USP-grade glycerol at 260° C. (isothermal operation), 625 psig, and a weight hourly space velocity (WHSV, g (glycerol)*g⁻¹ (catalyst)*hr⁻¹) of 1 hr⁻¹. Remarkably, the present Cl-free catalyst displayed effectively identical performance as the chlorinated catalysts, including catalytic activities as measured by hydrogen yield or conversion to gas rate. ICP and H₂ chemisporption results of the conventional chloride-containing catalyst and the present Cl-free catalyst (Table 1) demonstrate that these catalysts have similar Pt and Re content. However, the catalyst prepared by the present method using non-chlorinated Pt precursor showed significantly higher dispersion (%) and metallic area (m²/g). Importantly, control tests showed that a one-step catalyst synthesis is generally not possible under the tested conditions. When an aqueous solution of (NH₃)₄Pt(OH)₂ is mixed with HReO₄, rapid precipitation of a solid occurs, which makes incipient wetness impregnation impossible. Importantly, unlike the processes of King et al., the catalyst in this example is not calcined after Pt addition to the carbon support.

TABLE 1
ICP and H₂ chemisorption results

| | Cl-containing catalyst | Cl-free catalyst |
|---|---|---|
| | 5 wt % Pt Pt:Re_{0.5} | 5 wt % Pt Pt:Re_{0.5} |
| | on 80 × 120 | on 80 × 120 |
| | mesh Calgon 206P | mesh Calgon 208C |
| Description | (chlorinated Pt precursor) | ((NH₃)₄Pt(OH)₂ precursor) |
| Pt (ppm) | 42505 | 44995 |
| Re (ppm) | 22825 | 25585 |
| Ca (ppm) | 457 | 289 |
| Cr (ppm) | 185 | 203 |
| Fe (ppm) | 295 | 72 |
| K (ppm) | 299 | 659 |
| Na (ppm) | 29 | 67 |
| S (ppm) | 335 | 810 |
| Si (ppm) | 646 | 80 |
| Dispersion (%) | 14.1 | 21.9 |
| Metallic area | 2.15 | 3.58 |
| (m²/g) | | |

In summary, a chloride-free 5 wt % Pt Pt:Re_{0.5} catalyst was prepared using (NH₃)₄Pt(OH)₂ as a platinum precursor in a two-step process. The present Cl-free catalyst demonstrated good catalytic activity in APR process, which is similar to the activity of a conventional chlorine-containing catalyst prepared from a chlorinated Pt precursor (such as H₂PtCl₆). Thus, the chlorine-free synthetic method described herein provides a successful alternative route for preparing APR catalysts under improved safety conditions.

Although the invention has been described in considerable detail with reference to certain embodiments, one skilled in the art will appreciate that the present invention can be used in alternative embodiments to those described, which have been presented for purposes of illustration and not of limitation. Therefore, the scope of the appended claims should not be limited to the description of the embodiments contained herein.

For reasons of completeness, various aspects of the invention are set out in the following numbered clauses:

Clause 1. A method of preparing a catalyst, the method comprising:
contacting (NH₃)₄Pt(OH)₂, a carbon support, and a rhenium material to produce a Pt—Re/C catalyst.

Clause 2. The method of clause 1, comprising:
mixing a solution of (NH₃)₄Pt(OH)₂ with a carbon support to form a mixture;
drying the mixture to produce a Pt/C intermediate; and
impregnating the Pt/C intermediate with an aqueous solution of the rhenium material to produce the Pt—Re/C catalyst.

Clause 3. The method of clause 1, comprising:
mixing a solution of (NH₃)₄Pt(OH)₂, the carbon support, and the rhenium material to form a Pt—Re/C mixture; and
drying the Pt—Re/C mixture to produce the Pt—Re/C catalyst.

Clause 4. The method of any one of clauses 1-3, wherein the carbon support comprises activated carbon.

Clause 5. The method of any one of clauses 2-4, wherein the solution of (NH₃)₄Pt(OH)₂ has a Pt concentration of about 1 wt % to about 15 wt %.

Clause 6. The method of any one of clauses 1-5, wherein the weight ratio of Pt to carbon is about 1:1000 to about 1:10.

Clause 7. The method of any one of clauses 2-6, wherein the solution of (NH₃)₄Pt(OH)₂ is a solution of (NH₃)₄Pt(OH)₂ in water.

Clause 8. The method of any one of clauses 1-7, wherein the rhenium material comprises HReO₄.

Clause 9. The method of clause 8, wherein the HReO₄ is in an aqueous solution having a Re concentration of about 0.25 wt % to about 10 wt %.

Clause 10. The method of any one of clauses 1-9, wherein the weight ratio of Re to carbon is about 1:2000 to about 1:20.

Clause 11. The method of any one of clauses 2 and 8-10, wherein impregnating the Pt/C intermediate with an aqueous solution of the rhenium material comprises contacting the aqueous solution of HReO₄ with the Pt/C intermediate.

Clause 12. The method of any one of clauses 2 and 4-11, wherein the Pt/C intermediate is dried by heating at a temperature of about 100° C. to about 160° C. for at least 4 hours.

Clause 13. The method of any one of clauses 1-12, further comprising reducing the Pt—Re/C catalyst with hydrogen to produce a reduced catalyst.

Clause 14. The method of clause 13, further comprising subjecting the reduced catalyst to passivation with oxygen.

Clause 15. A catalyst produced by the method of any one of clauses 1-14.

Clause 16. The catalyst of clause 15, wherein the catalyst has a metallic area of about 3.0 m²/g to about 4.0 m²/g.

Clause 17. The catalyst of any one of clauses 15-16, wherein the catalyst has a percent dispersion of about 15% to about 25%.

Clause 18. A method of producing hydrogen, the method comprising reacting water and an oxygenated hydrocarbon in the presence of the catalyst of any one of clauses 15-17, whereby hydrogen is produced.

Clause 19. The method of clause 18, wherein the oxygenated hydrocarbon is a water-soluble oxygenated hydrocarbon.

Clause 20. The method of any one of clauses 18-19, wherein the oxygenated hydrocarbon is glycerol.

1. A method of preparing a catalyst, the method comprising:
contacting (NH₃)₄Pt(OH)₂, a carbon support, and a rhenium material to produce a Pt—Re/C catalyst.

2. The method of claim 1, comprising:
mixing a solution of (NH₃)₄Pt(OH)₂ with a carbon support to form a mixture;
drying the mixture to produce a Pt/C intermediate; and
impregnating the Pt/C intermediate with an aqueous solution of the rhenium material to produce the Pt—Re/C catalyst.

3. The method of claim 1, comprising:
mixing a solution of (NH₃)₄Pt(OH)₂, the carbon support, and the rhenium material to form a Pt—Re/C mixture; and
drying the Pt—Re/C mixture to produce the Pt—Re/C catalyst.

4. The method of claim 1, wherein the carbon support comprises activated carbon.

5. The method of claim 2, wherein the solution of (NH₃)₄Pt(OH)₂ has a Pt concentration of about 1 wt % to about 15 wt %.

6. The method of claim 1, wherein the weight ratio of Pt to carbon is about 1:1000 to about 1:10.

7. The method of claim 2, wherein the solution of (NH₃)₄Pt(OH)₂ is a solution of (NH₃)₄Pt(OH)₂ in water.

8. The method of claim 1, wherein the rhenium material comprises HReO₄.

9. The method of claim 8, wherein the HReO₄ is in an aqueous solution having a Re concentration of about 0.25 wt % to about 10 wt %.

10. The method of claim 1, wherein the weight ratio of Re to carbon is about 1:2000 to about 1:20.

11. The method of claim 2, wherein impregnating the Pt/C intermediate with an aqueous solution of the rhenium material comprises contacting the aqueous solution of HReO₄ with the Pt/C intermediate.

12. The method of claim 2, wherein the Pt/C intermediate is dried by heating at a temperature of about 100° C. to about 160° C. for at least 4 hours.

13. The method of claim 1, further comprising reducing the Pt—Re/C catalyst with hydrogen to produce a reduced catalyst.

14. The method of claim 13, further comprising subjecting the reduced catalyst to passivation with oxygen.

15. A catalyst produced by the method of claim 1.

16. The catalyst of claim 15, wherein the catalyst has a metallic area of about 3.0 m²/g to about 4.0 m²/g.

17. The catalyst of claim 15, wherein the catalyst has a percent dispersion of about 15% to about 25%.

18. A method of producing hydrogen, the method comprising reacting water and an oxygenated hydrocarbon in the presence of the catalyst of claim 15, whereby hydrogen is produced.

19. The method of claim 18, wherein the oxygenated hydrocarbon is a water-soluble oxygenated hydrocarbon.

20. The method of claim 18, wherein the oxygenated hydrocarbon is glycerol.
